(19) United States
(12) Patent Application Publication
(10) Pub. No.: US 2008/0030088 A1
(43) Pub. Date: Feb. 7, 2008

(54) COMPACT INTEGRATED BRUSHLESS PERMANENT-MAGNET MOTOR & DRIVE

(76) Inventors: Daniel Gizaw, Belleville, MI (US); David M. Erdman, Fort Wayne, IN (US); Joseph E. Miller, Fort Wayne, IN (US); Girma Desta, Suwanee, GA (US)

Correspondence Address: Thomas Moga;Butzel Long, STONERIDGE WEST, 41000 WOODWARD AVENUE, BLOOMFIELD HILLS, MI, 48304, US

(21) Appl. No.: 11/779,811

(22) Filed: Jul. 18, 2007

Related U.S. Application Data
(60) Provisional application No. 60/831,493, filed on Jul. 18, 2006.

(51) Int. Cl. H02K 11/00; H02K 5/18; H02K 9/18

(52) U.S. Cl. 310/64; 310/68 B; 310/68 C; 310/89

(57) ABSTRACT

The present invention is an integrated brushless permanent-magnet motor with the circuit board controller in the same chamber as the rotor and stator. Including the circuit board controller in the same chamber as the rotor and stator allows for a more compact motor. The motor may include fins on its housing exterior such that the heat generated by the motor flows out of the housing through the fins, cooling the motor. The invention may also include features designed to reduce cogging.

### BACKGROUND OF THE INVENTION

One challenge in electric motor design has been making more compact motors to fit new applications. A smaller size allows the motor to be packaged with other devices for additional uses. One of the challenges of a compact size is heat dissipation.

### SUMMARY OF THE INVENTION

The present invention is an integrated brushless permanent-magnet motor with the circuit board controller in the same chamber as the rotor and stator.

### DESCRIPTION OF THE DRAWINGS

The above, as well as other advantages of the present invention will become readily apparent to those skilled in the art from the following detailed description of a preferred embodiment when considered in the light of the accompanying drawings in which:

FIG. 1 illustrates a cross-section of a motor in accordance with the present invention; and

FIG. 2 illustrates a cross-section of the back plate of the motor housing in accordance with the present invention.

FIG. 3 is a circuit diagram of a control circuit used to control the invention.

### DESCRIPTION OF THE PREFERRED EMBODIMENT

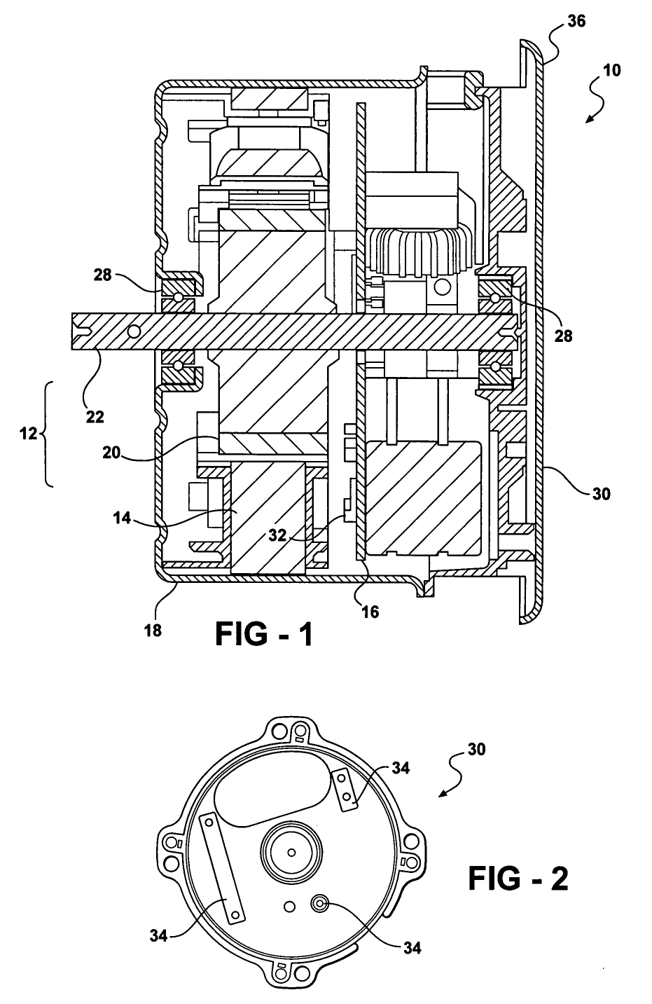

FIG. 1 illustrates a cross-section of a motor 10. The basic parts of motor 10 comprise an inside rotor 12, an outside stator 14, and a circuit board 16, all contained inside a housing 18. The rotor 12 consists of a skewed permanent magnet 20 affixed to a shaft 22. The stator 14 consists of a stack of magnetically conducting laminations with wire coiled around the lamination teeth, and it is affixed to the housing wall 18. The lamination teeth have shoes with subteeth. The rotor shaft 22 is rotatably connected to the housing 18 by two bearings 28. The circuit board 16 is located within the housing 18, which reduces the overall size of the motor 10. The circuit board 16 is connected to the back plate 30 of the housing 18 with metal bars 32 (or another highly heat-conductive material). These bars 32 hold the circuit board 16 in place.

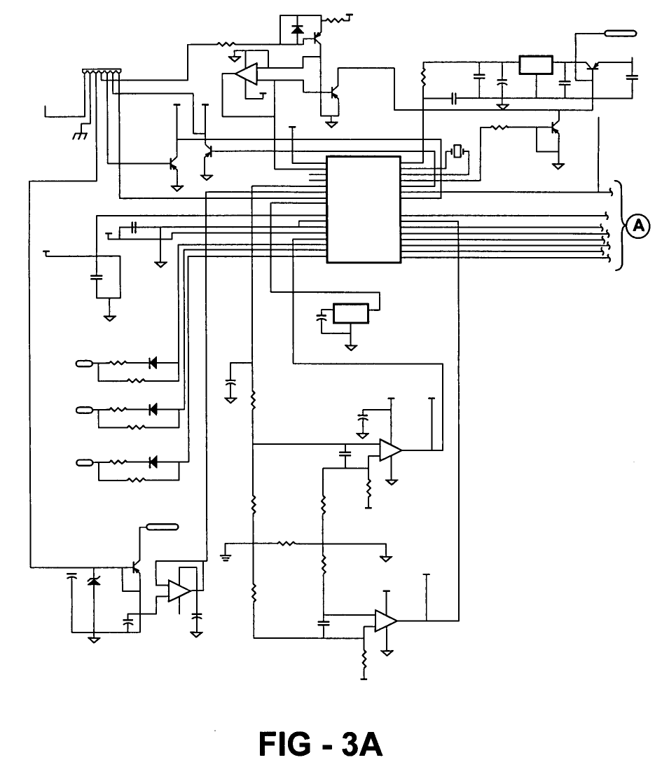

FIG. 2 shows those connection points 34 on the inside of the back plate 30. The back plate 30 of the housing 18 has fins 36 on the outside to aid in cooling.

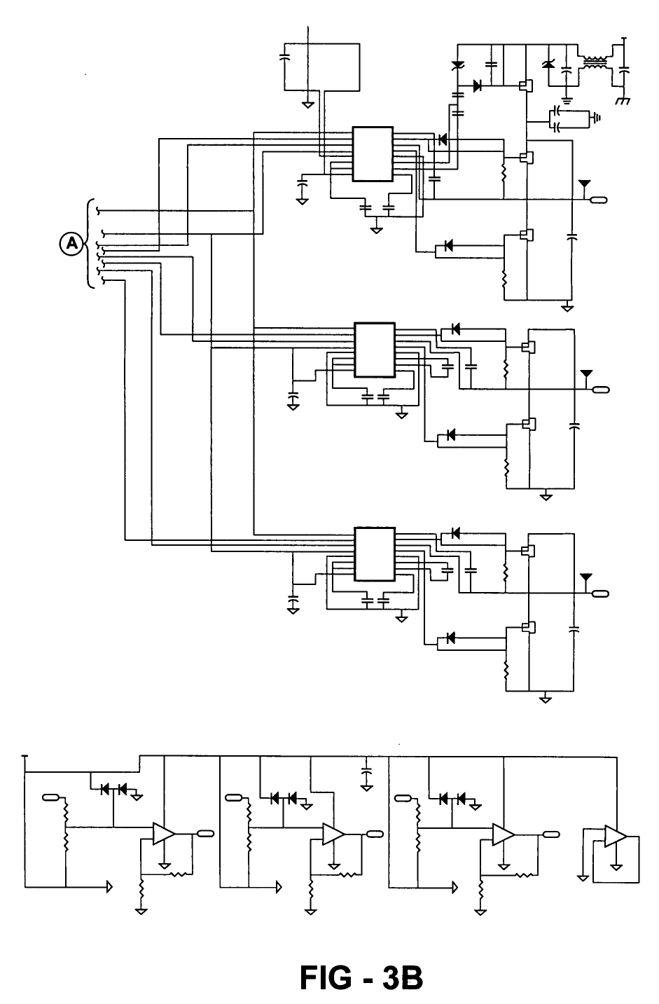

FIG. 3 shows is a circuit diagram for the motor control circuit. The circuitry on the circuit board 16 is equipped to monitor speed and temperature to self-diagnose, and to exercise multiple-input control. The motor control circuit controls the energization of the motor windings, protects the motor and control from excessive temperatures, excessive currents as well as to communicates with an external master control system.

The circuit is based on a microprocessor controller U6. It communicates to the master controller through connections W3-W7. U9 and its associated circuitry measure the motor current and interface to the microprocessor for controlling the current and protecting against excessive current. U10 and its associated circuitry process the BEMF of the motor and interface with the microcontroller to control the proper sequencing of the energization of the motor windings. U2, U3, U4, as well as Q4, Q5, Q6, Q7, Q8, Q9 and their associated circuitry receive signals from the microprocessor and apply the energizing voltages and currents to the motor windings. U8 measures the temperature of the motor and control and communicates the information to the microprocessor.

This invention may also include features designed to reduce cogging. These features include, but are not limited to, the features described in the patent application for a Slow-Speed Direct-Drive Generator filed concurrently herewith. The features described in that application include the introduction of variations in the airgap using teeth with multiple protrusions on the stator lamination stack and building the teeth into the stator in a particular ratio and with measurements that coordinate the teeth, rotor poles, slot openings, teeth protrusions, and the notches between the teeth protrusions. These features are shown in FIG. 2 of the Slow-Speed Direct-Drive Generator application. In addition, cogging can be reduced by skewing the magnetic pole using a staggered skew or a continuous skew, as described in the application and shown in FIG. 4.

### OPERATION

The circuitry monitors the speed and accepts other inputs to control the speed of the rotor rotation. If the temperature gets too high or there is a problem, then the circuitry can shut down the motor.

As electricity flows through the stator windings, the shifting magnetic fields cause the rotor to rotate. The shape of the shoes, which have subteeth, and the skew of the magnet reduce the cogging torque and thus increase efficiency.

The heat generated by the circuit board flows out of the circuit board through the connecting metal bars to the back plate, and out of the back plate through its fins. Since the circuit board is in the same chamber as the stator and rotor, this action simultaneously cools the circuit board and the stator and rotor.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A compact integrated brushless permanent magnet motor & drive as shown and described.

2. An integrated brushless permanent-magnet motor comprising:
a housing including a rotor and a stator; and
a circuit board controller affixed in said housing;
wherein including said circuit board within said same housing as said rotor and said stator provides a more compact motor.

3. An integrated brushless permanent-magnet motor comprising:
a housing including a rotor and a stator; and
a circuit board controller affixed in said housing;
whereby the circuitry on said circuit board is equipped to monitor speed and temperature; to self-diagnose, and to exercise multiple-input control.

4. An integrated brushless permanent-magnet motor comprising:
a housing including a rotor and a stator, and having fins on its exterior; and
a circuit board controller affixed within said housing;
whereby the heat generated by said circuit board flows out of said housing through its fins, simultaneously cooling said rotor and said stator.

5. The integrated brushless permanent-magnet motor of claims 1-4 and further comprising at least one heat-conducting connecting bar for affixing said circuit board to said housing.
